(19) United States
(12) Patent Application Publication
(10) Pub. No.: US 2001/0049087 A1
(43) Pub. Date: Dec. 6, 2001

(54) System and method of distance education

(76) Inventor: Janet B. Hale, Reinholds, PA (US)

Correspondence Address: KEVIN R. ERDMAN, BAKER & DANIELS, Suite 2700, 300 Meridian St., Indianapolis, IN, 46204, US

(21) Appl. No.: 09/752,475

(22) Filed: Jan. 2, 2001

Related U.S. Application Data
(60) Provisional application No. 60/174,315, filed on Jan. 3, 2000.

(51) Int. Cl. G09B 3/00

(52) U.S. Cl. 434/350

(57) ABSTRACT

The present invention involves a method of distance education using internet communications. The method requires establishing a server which is connected to a communications network. The server has data information relating to an educational subject, with the data information including at least one of the following: information content, linked web resources, quizzes, and tests. The teacher and plurality of students are connected over the communications network. The teacher and students conduct a conference relating to the educational subject and referring to the data information. The server also provides a virtual school which is accessible over the communications network. The connection of students and teachers, and conducting their conferences, are implemented utilizing the virtual school. The virtual school includes a three dimensional representation capability. Also, a student work assignment arena is accessible over the computer network, where the assignment arena provides student assignment data files. The conferences involve a discussion relating to the student assignment data file on the assignment arena.

### BACKGROUND OF THE INVENTION

1. Field of the Invention

The field of the invention is that of educational systems. More particularly, the invention relates to educational systems for enabling student learning from remote locations through telecommunications.

2. Description of the Related Art

Distance Learning refers to situations where the student is physically removed from her or his teachers. Before telecommunications, exchanges between the student and other students and teachers could only be accomplished by sending written messages between the students and teachers. Telecommunications has changed this paradigm, allowing for telephone and video connections between the students and teachers with simultaneous transmission of text and work assignments such as by facsimile or e-mail transmission. Distance Learning is coming closer to providing an interactive educational experience that rivals in person schools. However, Distance Learning still has obstacles to overcome.

What is needed are further improvements to Distance Learning techniques and technologies to provide students with better interactive learning environments.

### SUMMARY OF THE INVENTION

The present invention provides an interactive on-line learning environment combining real video connections and chat rooms with document libraries of the student's own work and the teacher's home work assignments.

The present invention provides real video feedback and use real video to help establish a more personal and live experience for students. To succeed in an online learning environment students need to feel a part of things. Real video helps do that. We also provide daily feedback in what we call the feedback arena. Student s have their own password protected area where they can go to access daily comments from their teachers, grades and their report cards. A running tally of assignments uploaded each day as well as past due assignments are also recorded in the individual feedback sheets.

Another area is the upload arena. Students upload completed work in HTML format into their password protected student folders. There is no unreliable e-mail flying around. Complete, detailed multimedia portfolios are created throughout the school year as students upload their work. This system also allows teachers from remote locations to view student work as if it is a Web page. Teachers can then correct student work. Teachers also upload assignment sheets as well as feedback using the upload arena.

Students access their daily assignments via the assignment arena. This is also password protected. Confidential files relating to assignments, teacher comments etc. are contained here to prevent the general public from gaining this information. The daily assignments students access are also all custom designed and written. These are ever evolving and updated. Internet resources are used, being continually checked and updated, to supplement the curriculum.

As far as the conferencing and virtual classes go, programs are employed to reinforce concepts taught. Lessons and techniques have been implemented to compliment these kinds of learning. All the similarities present in a regular classroom setting are also present in an online community. We know how to apply technology in this new setting to provide an effective educational experience. The technology and teaching programs have been known and used for years. While teaching students is well known and widely practiced, no school has systematically and dynamically created interactive on-line schools which approach education as provided with the present invention.

Furthermore, the use of ICQ or internet chat functionality is a very important component of the present invention's distance learning program. ICQ allows the students and teachers to instigate instant chats, launch different conference applications and basically to allow hundreds of correspondences to pass between the members of the school each day.

Additionally, students engage in hands-on construction of 3-D spaces and interfaces. Tools available for building: TrueSpace, Bryce 3D, VRML, Realpublisher. Students also will explore sound and voice which can be attached or transmitted through the space, and images which can be generated by scanning or paint systems and mapped onto objects. In addition, controls to affect the behavior of objects, selectable surfaces, and links to Internet sites and other media are included into the 3-D scenes.

The present invention is called Willoway and is an interactive cyberschool. Willoway provides a full-time curriculum in the areas of language arts, social studies, and science. Students are placed on the Saxon math tutorial math series. Parents are fully responsible for the maintenance of this math program and giving the chapter tests. Parents may also opt to use a math program of their own choosing but this program must be approved and recorded for school records.

Willoway provides important supplementary interactive online lessons at least three (3) times a week using Internet conferencing programs. Video conferencing is just one of the programs used to accomplish educational goals. Willoway expects and requires attendance at the weekly conferences, student interaction and development of friendships, and that all assignments be uploaded on a regular basis. Willoway is not a school where a parent can place kids and expect them to succeed without daily and dedicated interaction on the parent's part. Willoway is a new type of “homeschool” and as such it is the responsibility of parents to make sure students are pulling their own weight and keeping up with school assignments. Willoway is not just an Internet school. Instead, Willoway facilitates many educational opportunities away from the computer. With the help of family members, students are expected to explore community resources, create hands on projects and participate in science experiments to enhance the learning experience. The Willoways curriculum and schedule expects that often Wednesdays shall be devoted to these outside activities.

Willoway utilizes an integrated approach focusing on the areas of Literature, Social Studies, Science, and Technology. A rigorous self-paced math program is expected of all students as Willoway conferences do not focus on math, just the above four subjects. Students are expected to stay current with all class assignments and to participate on a daily basis in our video conferences with their instructors and peers. Many times the instruction involves collaborative projects and it is the responsibility of each student to work as a team member for the benefit of all participants.

The present invention provides both one-to-one and one-to-many interactions that occur either via video conferences or other Internet conference applications. Students are encouraged to ask as many questions about procedures as they need during the first few weeks and they fast learn that it is a requirement to interact on a regular basis all throughout the school day. Thus, Willoway students may use as many as four conferencing programs a day and are willing to explore new programs regularly. For example, the following is an example of a daily routine of Daniel, a Willoway student:

8:00 a.m. Daniel fires up ICQ and he sees a message flashing on his screen indicating he has an incoming message. The message is from his teacher telling him to check his daily feedback sheet in the upload arena. Daniel goes into the upload arena to access the daily feedback sheet. This feedback sheet has comments on his progress as well as suggestions. His instructor has sent back comments on his realaudio tribal speech. Daniel reads the revisions and comments from his instructor and notes any missing assignments he needs to do today.

8:20 a.m. Daniel next goes into the assignment arena to read and print out the daily assignment sheet. He makes sure he checks the conference schedule as this can sometimes change at the last minute.

8:30-11:00 Daniel gets started on the daily assignments. He decides he had better read the next twenty pages of Jaguar, a novel he is reading by Roland Smith dealing with the rainforest. Today's conference deals with literature so Daniel wants to be prepared. He noticed there are a lot of Web links with today's assignment sheet so he makes a mental note to try to split up his time wisely. ICQ flashes with a message for Daniel to launch the chat feature—one of his classmates needs to have a quick meeting so off they go into a private chat using ICQ.

11:00 am. Daniel starts up Classpoint, one of many video conferencing software packages used at Willoway. Soon, ten familiar faces begin to appear on his screen . . . everyone is already there, including his teacher! Daniel puts the finishing touches on his tribal mask he made as a culminating activity to our rainforest project and gets it ready for his group to view. He carefully positions it at the best angle so the camera can get a good shot. Daniel smirks to himself with the satisfaction that the other kids will find his mask both authentic and funny. He has spent a great deal of time working on this rainforest project and has visited hundreds of Internet links involving this theme. He feels confident in what he knows. This rainforest project has been the hardest, but also the most fun. Daniel developed close friendships with two of his “tribal” team members during this project. His assignment was to research an indigenous tribe of the Amazon, and then to actually become part of this tribe during an ongoing online simulation with other students from across the country. Students learned how to become part of a group, to cooperate, the effects of development on the Amazon, and about ethnobotony and the biodiversity of the rainforest. As part of this project students created masks to represent their tribal character. All finished masks are to be presented the exhibition. Soon, everyone is sharing their masks and everyone relaxes. Their teacher congratulates them on an excellent job and encourages those students with digital cameras to take shots of their masks and jaguars to archive and showcase on the Willoway Web site.

12:-00-1:00 . . . Daniel reads his novel and starts work on the humanities assignment. Most units at Willoway are fully integrated so Daniel's novel at the moment is Jaguar by Roland Smith. This fits in beautifully with the Jason X project as well as social studies.

1:00-1:45 Math: Daniel works on his Saxon math program.

1:45-3:00 . . . This is Daniel's favorite time of the day . . . putting together all the day's work into multimedia Web documents. After the assignment sheet is complete, Daniel uses WS-FTP to upload and the day is done!

3:00 . . . Time for a break . . . see you tomorrow . . .

Technology can and does provide valuable learning opportunities at a distance, but Willoway feels humanizing the process for students is critical to their success. For that reason, Willoway has incorporated collaborative requirements, deeply rooted interactive live events which strive to contact kids, teachers and parents in an emotional and intellectual environment. Willoway could not have traveled down this road without the help of our pioneering families. An adventurous spirit, a quest for the best educational experience for a child, and the parent's desire to be directly involved in their child's education are the three main criteria for a Willoway family. This kind of educational experience in not for everyone . . . but it is for many! Willoway focuses on technology and science to motivate children and interweaves arts and humanities throughout the curriculum to ensure children get the best educational experience. Willoway also teaches Internet and computer technologies. Children are facing many new demands in our changing society. Willoway focuses on technology and prepares children for a technically oriented society.

Willoway has experience and know what works and how to conduct effective virtual classes using a combination of conferencing programs including videoconferencing. Videoconferencing with students can be remarkably effective, motivating and fun if certain software packages are used to enhance this process. Willoway knows what works and what doesn't and how to bring the best out of its students.

Willoway, unlike many distance education programs on the web are not “canned” curriculums similar to what is offered in public schools. Everything offered at Willoway is custom designed to fit the needs of today's kids. Willoway's curriculum is custom designed. Willoway uses interactive web based lessons and students create HTML assignments related to what they discover.

Willoway provides important connections between kids which are critical for the development of all social skills. The Willoway method requires that students collaborate with other Willoway students. This teaches kids how to meet deadlines, get along with others, and helps remove some of the isolation kids feel from time to time with homeschooling. Parents act as facilitators in their child's education. Parents do not teach the curriculum, but without the parents, there would be no school. Parents help encourage students to meet deadlines, give input on assignments, take students on related field trips, plan outings with other Willoway students who live in their area and are the backbone of the school.

Willoway is dedicated to the proposition of producing technically literate students able to contribute in an ever-increasingly digital world. The Willoway School recognizes that each child is a unique individual. Willoway is dedicated to meeting the needs of the whole child while encouraging all children to reach their fullest potential. Willoway believes that individuals differ in their capacities and needs and that all children should be accepted, valued and nurtured.

Willoway helps the child develop the ability to recognize problems, take charge of their learning, and to take an active role in the responsibility of their education. Teachers act as guides in the teaching-learning process, helping students at Willoway reach their highest potential. Parents are directly involved in their child's education and are critical to their child's growth and success.

Using today's latest technology, Willoway opens the doors to the world to excite, expand and encourage children to reach their highest potential. Students at Willoway use internet resources, collaborate on group projects, interact one-on-one with their fully certified instructors, and through the convenience of video telecommunications, students can “see” their instructors and peers.

No longer are students confined to the classroom for educational instruction. Today's children are facing supremely different challenges than children in the past. Our world has many unfortunate scenarios, but it also has a multitude of goodness. Willoway helps children face problems head on, teach them how to take charge of their learning, and look for solutions to today's problems. Learning is a life-long responsibility . . . children can learn how to use technology to overcome problems and truly make a difference in society.

The present invention, in one form thereof, involves

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a schematic diagram view of the present invention.

Corresponding reference characters indicate corresponding parts throughout the several views. Although the drawings represent embodiments of the present invention, the drawings are not necessarily to scale and certain features may be exaggerated in order to better illustrate and explain the present invention. The exemplification set out herein illustrates an embodiment of the invention, in one form, and such exemplifications are not to be construed as limiting the scope of the invention in any manner.

### DESCRIPTION OF THE PRESENT INVENTION

The embodiment disclosed below, named the Willoway Cyberschool, is not intended to be exhaustive or limit the invention to the precise form disclosed in the following detailed description. Rather, the embodiment is chosen and described so that others skilled in the art may utilize its teachings.

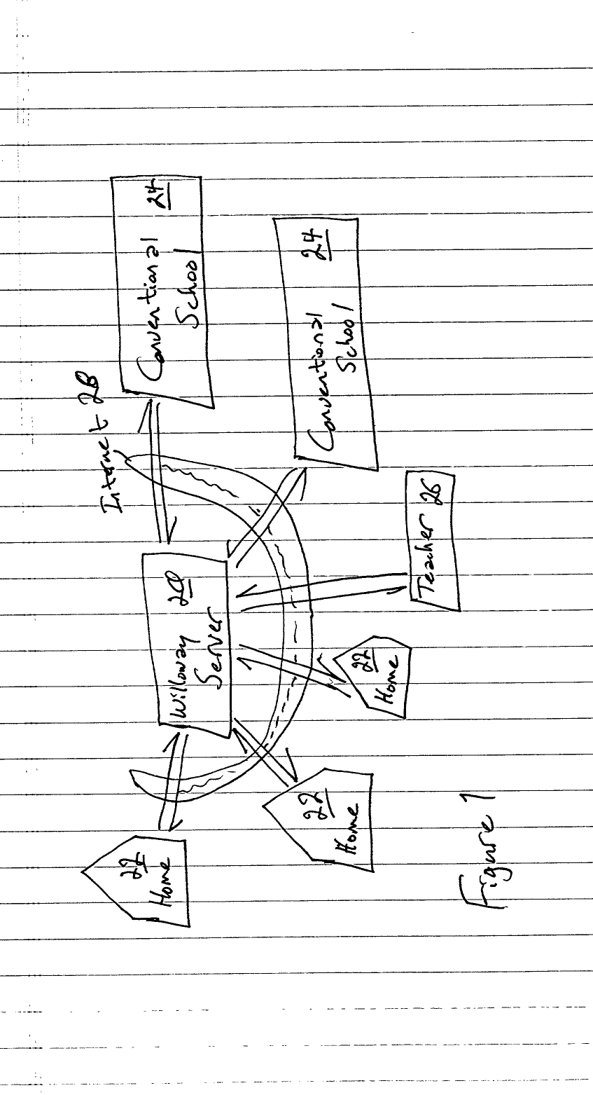

FIG. 1 shows a schematic representation of the computer/communication configuration of the present invention. Willoway server 20 contains the substantive content of the curriculum which may be accessed by homeschool students from homes 22, or by conventional students from conventional schools 24. Teacher 26 may be physically located separate from Willoway server 20, uploading class notes, interet hyperlinks, quizzes, and tests. Further, teachers and students may communication over internet 28 without the assistance of Willoway server 20. This arrangement involves a unique arrangement of available technologies enabling interaction by computer and telecommunications technology.

The Willoway system helps today's families meet the challenges of educating tomorrow's children. For students who are currently homeschooling, the Willoway school can be the supplement or core for the student's learning. Alternatively, for parents seeking a high-quality private school where parents can closely monitor and be a part of their child's educational experience, Willoway can also provide a solution. A benefit of the Willoway curriculum is the technology aspect. Teenagers are coming into a world that is technically oriented and they must be prepared and experienced in all aspects of technology. Research on learning has provided educators with valuable criteria to work with to improve the way students learn as identified in the 4 Points below.

Point 1: Teenagers actively construct their knowledge. Willoway enables students to, see, talk express, write, explore, create, collaborate and connect teens, student to student.

Point 2: Teenagers create new knowledge and express themselves primarily through language (speaking and writing). Willoway helps students become better communicators in all areas. E-mail messages, file transfer of stories, entering live chat messages to their peers, verbally talking with other Willoway students.

Point 3: Teenagers learn reading and writing in social contexts which has a major impact on how well a student learns. Willoway's social groupings help students understand their world, respond to learning and improve comprehension.

Point 4: Teenagers learn through interacting and talking with others. The Willoway school uses a video reflector is a wonderful tool to connect and nurture the Willoway community and help students reach their highest potential.

### Willoway Cyberschool Basics

One of the most prevalent differences in the Willoway environment is the relationship between the student and teacher. Teachers at Willoway act much more as facilitators and mentors than in a regular classroom setting. The teacher/student relationship is a much more personal relationship and leans more towards a personal friendship. The thousands of the daily interactions teachers send each day to all students enhance this relationship and that in itself forces the change in traditional role of the teacher.

Students come from varying backgrounds. Some are needy socially, some need more help academically, some need prodding to communicate more often. Regular classroom teachers are used to keeping their students quiet and do no encourage students to discuss concepts and interact. The reverse is true of a Willoway teacher. What sets Willoway apart is the fact that Willoway offers an interactive learning environment where students and teachers can come together.

The middle school years are important years of socialization growth as well emotional maturity, and this is the Willoway cyberschool's focus. Kids of this age have a need for humor in their daily routine. Knowing when and where to interject humor can be critical in the development of relationships with students. For instance, if teachers are too serious, the learning experience will not be as fun but if teachers are too laid back and not enough of a disciplinarian, the students will not respond when needed. In other words, if students look at teachers as someone who does not hard work and one who likes to joke on are regular basis they will not perform. Finding that fine line can be tricky but humor has the ability to really loosens things up for students and teachers.

With those thoughts in mind, here are some useful tips on how to handle the daily interactions that occur using ICQ. Once a teacher signs on in the morning, the teacher will not find it uncommon to have students contact the teacher all at once if the students are online. Setting up ground rules from the start will be a big deterrent for future problems down the road. The teacher can set up ICQ to send a message to all appropriate students. For example, a teacher may want to send a “good morning” hello to all students, or set up a daily opening with students where they come in the ICQ chat conference to say hello and get the day started. The only drawback to this approach is the fact that some of students may not be on-line at the same time as others etc. The main thing to remember is that it's important to establish that daily contact and to make students feel as if teachers are approachable.

On the other hand, it's also a good idea to go over the ICQ guidelines as one of the first student conferences during the first week of school. Students need to understand the different ICQ icons that indicate where and what the user is doing. If the ICQ icon of the user has the DND sign on then the person should hold off sending a message. Students should be taught that if they see the “away” sign users are away from the computer at the time. Rules should be reinforced right from the start.

For each class, teachers should sign on five minutes before conference to make sure that the connection is established. The camera may be turned away if the teacher is not ready to have students view, but video should not be paused at this point. Students entering the conference need to be able to open the teacher's video stream. Type a welcome message saying you will be there at the time class is set to start. Students should be allotted five minutes to establish their own connections but then class should be started after that time. Students should be allowed to connect only 10 minutes late. This is because teachers will need to start a web tour to the class, including forwarding and explaining materials, and those actions can not be done for students who arrive late. Students should be well informed of this stipulation. Each conference should begin with some kind of routine, such as saying, “Hello everyone . . . I'm ready to start now.” Continue by saying, “If you are ready . . . please type READY in the text box.” That way you can see who is listening and who is not.

Once every student is ready, the teacher should spend a few minutes telling them what the conference topic/agenda will be. Then, inform students that the web tour is going to start. The teacher will then go to the assignment sheet and then discuss/follow as the case may be. It's also a good idea to focus the conference on one topic only. For instance, even though students may have both language arts AND either science or social studies, teachers should not try to cover both. Refer to the conference topic sheet for guidelines on what subject should be covered on what day. Teachers should always transmit video except for when running application sharing or the whiteboard.

Teachers should not give every student the spotlight ALL the time. It's a good idea to give students the spotlight during the first 5-10 minutes of any conference, but then once things get started, revoke the spotlight for all students so they will be focused on the teacher. Individual students may request the spotlight during class. Students need to get used to the fact that there are other learning options than just SEEING each other during conference.

To gauge and encourage student participation, teachers should randomly call on students to answer questions. If a teacher feels a student is not listening, the teacher should contact the student using the PRIVATE CHAT feature to send a message. Do not use ICQ as it seems ICQ slows down the Class interaction. Five minutes before conference time is over, the teacher should summarize what the discussion and open the floor for discussion. If there are no additional questions then the conference should be closed.

Student work folders should be checked by teachers either each evening or morning so that comments may be added as needed. Teachers may decide to add RealAudio messages, that is an audio/visual recording which may be played back by the student's computer, occasionally to enhance the feedback process.

Daily assignments are not graded however it's very important that teachers give more than one sentence comments on individual assignments, especially in the area of language arts. Final projects will be assigned letter grades based on the criteria set forth for the project. QuizPlease tests and quizzes are automatically scored if the multiple choice, true false option is selected as the test format. All other test made with quiz please will need to be hand-scored.

### Curriculum

The curriculum of the Willoway School follows various state guidelines of homeschooling and is modified to meet each states individual requirements. Some states require 175 days of instructional time where others require more. Some states require local and state government taught where others require only United States history. Willoway researches the exact requirements for a student's state and designs appropriate curriculum to meet regulations. For the most part, Willoway's curriculum does not need to be modified except in minor instances. Willoway does not provide instruction in physical education or music so if a state requires this as part of its regulation, Willoway will notify the parents and help them choose appropriate material to meet this requirement.

Willoway keeps careful documentation for submitting to superintendents, provides all necessary professional evaluations, and compiles the best evidence worldwide of effective learning—the portfolio. Using high quality trade books as well as a supplemental genre study series published by Scholastic, Willoway covers the following mini lessons to discuss, respond and write pieces of literature. All writing skills, reading skills, grammar and spelling skills are taught in the context of these assignments. For example, the methodology of the present inventions system is detailed below:

### Responding to Literature

1. How the Author Wrote: Descriptions and details: Could the student see it happening? Feel it? Dialogue: Is the talk realistic, full of voice? Could the student hear the character's voices? Too much dialogue? Too little? Lead: How did the author bring readers into the story? Conclusions: How did the author leave readers? Was the ending satisfying? Flashbacks and Foreshadows: How the author used shifts in time and why. Humor/Sadness: did the student laugh? Cry? Why? Specific learning that took place . . . what did the reader learn? Character Development: How were the characters' actions, thoughts, and feelings shown? Where they believable? Could the reader enter the character's hearts and minds and see through their eyes? Main characters: Who are they? What makes a main character? Titles: Was it appropriate? Was it a grabber? Realism: could the reader believe in this plot? Suspense: Did the reader wonder what would happen next? Action: Was there enough happening to hold a reader's interest? Too much action and not enough character development? Grace of language; did the sentences flow? Where they too choppy? Plot: did the story hold together? Go on and on? Epilogues and Epigraphs: How are these special introductions used and why? Prefaces and Introductions

2. The Author. How the author accomplished the writing. Other titles by that author/Sequels. Comparisons of other books by that same author. Drawing on biographical information on that author to understand the impact of real life on writing. Ways authors use their own knowledge and lives in their books. Ways authors might have researched subjects for their books. How to find authors addresses. Reviews of authors. New releases of authors.

3. The Readers Process/Comprehension. Skimming and skipping. Abandoning. Re-reading certain parts of a book. Planning ahead/thinking about reading a particular book. Predicting. Revising, Other ways the author could have written the book. Length of time it takes to read a particular book. Strategies when a book is too difficult. Where a book was read. Connecting what you are reading to what you are writing. How the reader decides what to read. Whether a reader buys/owns/collects books. Problems a reader is encountering and possible solutions.

4. The Reader's Affect. Also response questions and book talks. How the book made the reader feel. What the book made the reader think. Connections between a book and the reader's own life. What the reader thinks now that they didn't think before. Comments about other readers' reactions. What the reader liked/didn't like about the book. Best and worst aspects of the book. Rating scales for books, good math connection.

5. Recommendations. Whether a book is worth recommending. Others who might enjoy a particular book. Titles of other books similar to the recommended book. Names of good authors. Where to find a particular book.

### Specific Mini Lesson Topics for Writing Workshop

Elements of style: Leads, Cutting clutter, Dialogue, Flashbacks, Foreshadowing, Alliterations, The Climax, Characterization, Similes, Metaphors, Personification, Settings, Transitions, Sensory details, Showing not telling, Developing your heroes and villains . . . essential to good writing, Conflict, Exact words, Rhythm and flow, Making the reader feel emotion . . . mood . . . atmosphere.

Elements of the writing process: Organization of writing workshop, Prewriting, Brainstorming, Oral composing, Role-playing to find ideas, Researching, Organizing writing, Drawing and diagraming, Journals.

### Observations

With the Willoway system, communicating language skills involves: Drafting, Revision, Submitting to magazines Markets that publish student writing, and Class magazines.

### Examining Genres

This aspect of the Willoway curriculum examines Novels . . . types . . . what makes a novel a novel? Poetry, non-fiction, Autobiography, Biography, Historical fiction, Science fiction/Fantasy, Adventures, Westerns, Sports, and Horror.

### Arts and Humanities

Students study American History in grades seven and eight. Ancient Civilizations and World Mysteries are covered in ninth grade. If state regulations call for state and local history, the student will receive custom designed material and be placed on a collaborative team to fulfill this requirement. Archaeology and social sciences are also covered in this track. Artifacts uncovered by archaeologists reveal a lot about history. Willoway does not delve into the sensitive issue of evolution in this track nor anywhere else in our curriculum. We focus on historical issues, trends in cultures, how technology has developed over time and what the implications on our world this has. Willoway has total integration of language arts material into all areas of the curriculum.

### Summary of Points Covered in Arts and Humanities

The Willoway seventh grade curriculum includes the following topics: The First Americans, The Mound Builders, The Mississippians, Archaeology, Architecture, The Indians of North America, The Vikings, The First Explorers, The French and English in America, The American Colonies, The American Revolution, Communication and Language Development.

The Willoway eighth grade curriculum includes the following topics: Opening the Way West, America on the Move, The Civil War, The Westward Movement, Settling the West, Building citizenship . . . People who make a difference, and The Rise of Modem America.

The Willoway ninth grade curriculum includes the following topics: Ancient Civilizations, Egypt, Mesopotamia, The Maya (in depth concurrent with rain forests in science), The Minoans, Pyramids, Greek Civilization, The Rise and Fall of Roman Civilization, The Middle Ages: A Time of Change, The Renaissance, The Age of Discovery, World Mysteries, Easter Island, Lines of Nazca, and Stonehenge.

Art History in the Willoway system focuses on changes during these historical times. Students take virtual field trips to the Philadelphia Museum of Art, The Louvre in Paris, the Smithsonian Institute and other museums via the Internet. Collaborative projects center around the current historical perspective being covered each quarter.

### Technology Track

The main focus of study at Willoway is an in depth exploration of the Internet and the resources it offers. Under close parental supervision, Willoway students are expected to explore and gather research information from key predetermined links to enhance all tracks at the school. Willoway has carefully screened all required links for appropriate content, however, it is the responsibility of individual families to supervise students while using the Internet. One component of this study involves web site design, including the following topics: Html and all aspects of creating web pages: Graphic design, Animation, Digital photography, Skills related to the Internet, E-mail, FTP, Composing on-line responses to questions, Using videoconferencing programs, Learning how to search Internet data bases, RealAudio Publishing, Sound File Conversions, VRML, and Designing Virtual Communities.

### Science Track

Science is a process for enhancing the natural world, and technology is the application of that knowledge to meet our needs. More and more, sophisticated technologies are becoming an integral part of our lives. On the practical side, teenagers will have to adapt to new technologies throughout their working lives. As citizens, they will be required to develop informed opinions about new technologies and the social and ethical issues they may raise. The science track examines the relationships between science, technology and society. We also cover concepts in the three major areas of Life Science, Physical Science and Earth Science.

The science track has been carefully created to nurture the natural curiosities of teenagers. Teenagers are natural scientists. They're eager to explore their world, test hypothesis and manipulate objects in new and creative ways. The science track has four major components: 1. Exciting and stimulating multimedia Internet enhanced lessons; 2. A specially-designed hands-on component to accompany assignments; 3. Literature Connections; and 4. Technology Connections. Willoway has designed its science curriculum centered around the Circle of Learning, a multisensory learning model. The circle of learning embodies the idea that all students can achieve in science in an environment that ignites their senses and embraces their learning styles.

The circle of learning involves the following aspects:

1. SEEING: Using predetermined links, students explore key concepts for a particular unit of study. Graphic images of concepts, charts, graphs, multimedia stacks, live-motion video, computer animations, cross sections all come to life over the Internet.

2. HEARING: Students sign on to the Willoway conference arena and listen to their instructor describe key concepts, label visuals seen on the Internet and develop a shared language for referring to concepts.

3. DISCUSSING: By using videoconferencing as well as other conferencing programs to discuss what they have seen, Willoway students expand on ideas offered by others, and articulate emerging ideas and questions.

4. DOING: Students design models and experiments and put ideas learned to the test. ‘Doing science” strengthens students’ process skills and enriches their understanding of concepts. Willoway students love to present their collaborative projects via video.

5. READING: After students explore the lesson links and participate in group discussions, they read a language lab downloaded from our web site to enrich comprehension. They explore the topic further with nonfiction reading passages from their local library as well as other resources related to the concept.

6. WRITING: Students gain ownership of science concepts by communicating what they have learned. Writing activities, fictional as well as nonfiction, expand, help create science connections, and stimulate learning.

7. VISUALIZING: In this last stage of the Circle of Learning, students practice the art of imaginative extension. Students create their own projects related to the topic, seek out new information and take charge of the potential of new ideas.

For example, the following concepts covered in science for seventh grade students: Microworld; Microscopes; Plant and animal cells; An introduction to classification; Invertebrate animals; Fish, amphibians and reptiles; Plant structure and function; Adaptations and the environment; Neurology; Oceans—Coral Reefs, Deep Ocean, Hydrothermal Vents; Tidal Zones, Kelp forests; The Jason Project; Caves and Exploration; and Whales. In subsequent grades, students may enbark on a premed curriculum which may include, for example, Introduction to Anatomy.

### Cyberschool Operation

Willoway is a full-time interactive school—a school of the future where kids take charge of their learning and attend “virtual” classes. While the program is wonderfully individualized and caters to the specific needs of each student, the program is NOT something kids complete on their own at their own pace. They complete daily assignments, projects, attend classes and talk to each other all day long.

Here is a quick run-down of how this works. In the morning, kids access the private assignment arena and get their assignment sheets. There are assignments related to language arts, social studies and science. These assignments are worked on throughout the school day with interaction between their peers and the teacher using various conferencing programs. ICQ allows everyone to be connected all day long and to send instant messages to individual people as the case may need. Let's say a student has trouble finding a web link for the social studies lesson. He may instantly ICQ me and I can instigate an online conversation explaining what needs to be done. Students like to use ICQ to send each other personal messages just for fun and interaction too. The main and most important way we use conferencing at Willoway is to hold virtual classes related to the curriculum. We use both videoconferencing and software called whiteboard to accomplish this. The whiteboard is fantastic for online editing and group collaboration of writing pieces and to show illustrations and examples throughout the science curriculum. The videoconferencing also gives everyone in the school a feeling of connectedness and helps develop close personal relationships in the school. So, you can see, our program is not a self-paced do it yourself program. Students have to have interaction all day long.

Students are evaluated using a combination of assessment techniques. Performance based assessment (final projects demonstrating concepts taught) writing projects and pieces demonstrating growth and are the main ways students are assessed. Occasionally there are essay tests in both Social Studies and Science however our philosophy reflects the thinking that alternative methods of assessment more adequately reflect the individual thinkers of Willoway. Daily feedback is provided through RealAudio to help guide students on unclear concepts and give support through the daily assignments. Students are also issued quarterly report cards with letter grades with detailed written assessments for each subject area.

For math, the curriculum is set up to deal with third party instruction. Students are asked to visit another web site, for example the Saxon web site at http://www.saxonpub.com, to take the appropriate steps to obtain that supplemental education. Thus any cyberschool according to the present invention does not need to deal with every required subject, but does need to coordinate with other parties to ensure that the student receives a full educational opportunity.

As far as books go, Willoway students use web resources and background information they download from the Willoway web site almost exclusively for instruction. There are a few instances where novels are required. Willoway provides a full book list at the web site and selects novels widely available in most bookstores. Willoway recommends access to a public library or bookstore to find books that enhance what we are studying at the moment. The Internet provides students with the resources of the world, so that one day all books or other information may be available electronically.

Students upload their assignments on a daily basis and are provided with daily feedback so important in the distance learning educational setting. Willoway also provides a transcript of records. Willoway compiles an extensive student portfolio; both a printed out hard copy as well as all the student's work completed throughout the school year on the computer. All student work is uploaded everyday and is archived in their individual work folders. This work is an excellent record of student progress and growth throughout the school year. We also provide monthly student profiles indicating student strengths and weakness which are also archived in the individual student folders at our web site. At the end of the school year, each family is provided with a school transcript recording courses taken, grades received, test scores and student profiles. These transcripts are an excellent record of a student's time spent with us and can be submitted to other schools in the event of transfer.

Willoway truly believes that keeping kids actively involved in outside activities, homeschool groups, music lessons, etc., which is considered important to the success of the program. Family vacations are encouraged and usually students prepare some kind of final project upon their return sharing some of the highlights of their trip. Alternative assignments may be requested to take along with the student if the parents so choose. There are not set times the students have to be online working on assignments other than the videoconferences that meet three times a week. These conferences are tentatively scheduled for these days and times for every Fall.

A typical schedule involves utilizing selected days of the week, e.g. Mondays, Tuesdays, and Thursdays. For a three grade school, Periods Of Discussion (or “POD”) may be scheduled as: seventh grade POD 11:30-12:15 EST, eighth grade POD 12:30-1:15 EST, and ninth grade POD: 1:30-2:15 EST. One advantage of delivering instruction via the Internet is the wonderful flexibility if offers students. They have access to the assignment sheet at the web site any time . . . day or night. They also may upload their daily assignments as soon as they are complete or later in the evening if they need more time. Willoway has found that although the kids are not required to be online at any certain time they soon want to do so. One of important distinctions from other homeschool programs is the daily interaction between everyone involved with the school. Using a program called ICQ to connect everyone together and to “talk” , students ask questions and communicate all day. Most Willoway kids spend on the average of 4 to 5 hours a day doing school related tasks.

### Student Perspective

The Willoway student experience will depend on the student's ability to be self-motivated, a hard-worker, and to work with the computer. Each day, the student should check the student's RealAudio feedback page in the assignment arena first thing in the morning. This feedback will have a listing of missing assignments, suggestions from teachers and helpful comments about your progress. Next, the student should go to the daily assignment sheet at the Willoway web site. Conference days and times should next be checked as times are not always the same as schedules due to “bandwidth” and other technical drawbacks to the Internet. Usually, a student can expect to have, at a minimum, four conferences, each about 50 minutes long, a week. These conferences are an important way for students to stay connected as well as to learn new information. A typical student schedule may progress like this: 8:00 Check feedback arena of web site; 8:30-9:15 Independent Reading/Reading Workshop; 9:15-10:00 Writing workshop activities; 10:00-10:30 Break for other self-selected activities; 10:30-11:15 Arts and Humanities; 11-15-12:00 Lunch/Check e-mail; 12:00-12:45 Science; 12:45-1:30 computer/internet activities; 1:30-2:20 Video Conference (note that students outside of the teachers time zone may need to adjust the conference time if in a different time zone); 2:20-2:30 Break; 2:30-3:15 Math; 7:00 upload the day's assignments.

The preceding is what a student's day my typically look like from a scheduling standpoint, and the following describes its substantive content. First of all, the assignment sheet will have a reading activity, writing activity, social studies assignment, computer assignment, and science assignment. Students will be expected to stick to the time frame for each subject. If a student finishes before the end of one time frame, the student will be expected to choose from other related independent activities. In other words, students are expected to be reading during reading, writing during writing, and doing computer programs at the appropriate times. Although students will be supervised by parents to help ensure that this schedule is maintained, Willoway expects the students to treat this experience as a new way to go to school. If it looks like a student is getting ahead in certain subjects, the student's curriculum can certainly be adjusted to spend more time on learning new computer programs, but initially students should stick to the above schedule.

Students are also advised to follow some general suggestions. The student work space should be set up so that is quiet and free of distractions. Sufficient light should be present in the computer area. Students should have a desk light shining on the keyboard to make the video transmission more clear. A small desk light with a flexible arm is a good choice because it lets the student aim the light where needed. The student should have a desk to work at, rather than trying to do written assignments laying on a bed. Reading on a bed or in a comfortable chair is fine, but use the desk should be used for written work. Most written work assignments will be on the computer, but sometimes, assignments will be in notebooks. A work table should be provided for the student next to the computer for science displays and experiments as well as to showcase the many 3-D projects students will make. Video conferencing is much better if other students can see all the neat things made in conjunction with the Willoway curriculum. A card table, folding table or old desk will do, and should be as close to the computer as possible. Students should also have assembled as many of the school supplies as possible so that students are not always searching for things at the last minute. Plastic storage bins with covers may be used to store and organize student supplies. Science materials students might need are on the Willoway web site science section in the student center. Art supplies, such as colored construction paper (preferably large sheets); poster board of various colors; bright markers (colored pencils don't show up well during conferencing), scissors, glue, pencil sharpener, and erasers should also be obtained.

Going to a online school will be new to most students. Students should understand that all students and teachers of the Willoway school are very close and that students will be expected to try to work together with the other students as much as possible. This means that students will be expected to contact“peer-partners” as often as possible as well as follow through with collaborative projects assigned to peer-partner pairs. Students will be expected to work with different partners during the school year so students can get to know everyone! Students from different grade levels may also work together. Personal interaction between kids is one of the most important parts to this school and students will actually get graded on this requirement.

During a student's first week, the student will probably notice that there seems to be a lot of work to be done. This is because the student will not be familiar with the Willoway school workload. It will take at least three to four weeks until a new student really gets into the swing of things with Willoway. While it really does take a lot of work, but it is FUN work! So students should relax, as there are a lot of people ready to help new students through the first few weeks and before long, the student will be in the position to help another new Willoway student.

### ICQ Guidelines

This is a very important guideline sheet as ICQ is our main way to stay connected during the school day. Please read the ICQ tutorial as well as the “Rumors” sheet. New users of ICQ should pay particular attention to the following rules we have established for Willoway:

1. Select “Must Authorize User Before Adding to Contact List” under the security tab. This will give the student complete control over who is added to your contact list and who is not. Never authorize or add people to a list who are not part of the Willoway student body unless the student's parent's permission has been obtained.

2. Students should not fill in personal information other than the first name. It is not required and provides not additional benefit to using the ICQ.

3. ICQ comes with handy icon indicators representing student's on-line status. Students MUST respect these icons at all times. For instance, let's say a student steps away from the computer to go into the other room. There is a little “away” sign that the student should switch over to. There is a DND (do not disturb) sign as well. This icon looks like a little “Shhhh” finger. If a student sees that icon up someone is hard at work and prefers not to be contacted at the moment. RESPECT their wishes.

4. It is a good idea for students to consider keeping the ICQ program on at all times during on-line hours although that is optional. If a student is spending too much time off-task then the student might consider limiting ICQ hours to match those of the student's teacher. Willoway teachers will have set ICQ hours for the school day. Students should always be aware of the times that the teacher will be on ICQ and plan accordingly.

A teacher's job here at Willoway is much more involved than in a regular classroom and just because a teacher is not on ICQ does not mean the teacher is not online researching lesson plans, correcting your work, and doing the intensive technically related things this kind of program demands. If a student does not see a teacher on ICQ and the student has a question, the teacher may still be contacted by e-mail. Students can minimize contact problems by planning accordingly and trying to be on-line at the same times the teachers are if a student anticipates needing help.

### Video Conferencing Guidelines

A “video” conference implies that recipients will be able to view the speaker or the presentation. The better the lighting, the better the viewing experience. Video conferences where the sending site is “dark and fuzzy” are not fun to watch. Lighting for a video conference is much like lighting for good photos. Do NOT rely on overhead lights (fluorescent lights are the worst). Do NOT have a window directly behind the speaker (they will appear as a dark shadow). DO have a portable light that you can shine on the speaker “spotlight” fashion (a portable flashlight can be very effective)

When students are at computers and typing away, viewers mostly get to see the teacher's forehead. Teachers should try to make eye contact with the camera as much as possible. Students don't want to be staring at the top of the teacher's head all the time. If using audio, the speaker should look directly into the camera as speaking, much the same way newscasters do. Sending audio over the Internet is still a bit primitive. On good days the audio can be very clear, but on busy days audio can be very choppy. There are several things that students and teachers can do to improve audio transmission over the internet: (1) pause the picture (this helps a lot) and talk very slowly (to prevent entire words from being lost); (2) talk loudly and distinctly (this is simple good speaking advice); and (3) vary the tone of your voice (talk with passion). There will be times when students and teachers are asked to present projects and share learning. Presenters should think of themselves as “story tellers.” The use photos and props to enhance stories is recommended. Sometimes pictures will be used as well as other artwork. To obtain good transmission of such images, simply hold the photo or drawing in front of the camera and pause the picture. Then tell the story that goes with the picture. This approach is much more effective than watching just the person's head all the time. Students and teachers should always open the chat box right away during a conference and also watch to see if there is any request to open the whiteboard. Many times the chat box will be the only way one is able to communicate with EVERYONE simultaneously.

Students and teachers should also remember that they are on camera, even when not the ones who are speaking. It is very distracting to see viewers fidgeting, yawning, or talking amongst themselves. Proper etiquette is to give your full attention to the event. If you must divert your attention, pause your picture, so that the other participants are not distracted. Further, try not to do personal things like brush your hair etc. while on camera.

### Interactive Software

The following is a listing of the various interactive computer programs which enable the Willoway Cyberschool's methods of operation for both the Cyberschool itself, its teachers, and students. In a general sense, this is a summary of what Willoway uses to achieve the innovative interaction between students and their teachers:

RealPublisher: This is used by the Willoway server to create instructional materials and provide individualized daily student feedback and communications with parents.

G2 RealPlayer: Students use this to play the RealAudio Content on their home personal computer.

Real Server: This is used by the Willoway server to provide the RealVideo content.

Classpoint Videoconference software: Used for virtual classes, collaborative projects and Web tours.

Meetingpoint Server: This is used by the Willoway server to run the videoconference center.

The Palace Server: This is used by the Willoway server to run Willotropolis, the school's custom designed online community. This is an ever evolving environment and is useful in developing the on-line relationships desired for the Willoway Cyberschool.

The Palace Client: This is used by the students and teachers to access Willotropolis.

ICQ: This is the instant messaging program used by all Willoway participants to network Willoway students and teachers. Willoway has also considered using a more controlled application so that students access to outsider's may be more easily supervised by partents. ICQ is also facilitating the feeling of connectedness and on-line community.

### Use in Conventional Schools

Teachers are interested in finding ways to integrate technology into their existing curriculum but get information overload and burn out surfing the Web for appropriate projects to get involved in. Another drawback facing educators are the false expectations placed on them to come up with supplemental lessons and projects integrating technology. The multiple responsibilities facing today's classroom teachers makes the prospect of integrating the Internet a less than desirable task many times. There are endless and unrelated curriculum lessons and projects; from web quests to eduventures to thousands of lesson banks. Although these Internet activities might seem useful, they detract from what is really going on in the regular classroom and for the most part have nothing to do with what is being taught by individual teachers.

Just because students attend a conventional school does not exclude those students from participating in an on-line learning experience. The Willoway Cyberschool has thus developed a parallel program available to students in conventional schools: The Willow@School. The Willo@School curriculum is unlike anything ever developed for the Internet. Developed by a former classroom teacher, Willo@School is in touch with the pulse of what teachers really need in order to use the Internet in a seamless and effective manner. Teachers lead students to actively participate in the learning process. Students are actively involved, motivated and have fun in the process.

Willoway's Internet-centric approach is applied to a portion of the conventional student's work day and allows those conventional students access to comprehensive, fully integrated units in the areas of language arts, social studies and science focusing on topics that may or may not be taught in today's classrooms. For example, in a given school there may only be two or three students interested in learning about the Chinese language, Czech literature, or South American history. However, a cyberclass may be set up with suitable curriculum so that students in several geographically separated locations. Units include core content, linked web resources, integrated technology connections, and online quizzes and tests. Willo@School units have collaborative opportunities via video conferencing and our popular visual chat world called Willotropolis built right in. This is what makes the Willow@School program special—the online conferences designed to enhance the integrated units.

### Wilotown Further Technology Enhancements and Methodologies

Wilotown is the new and ever-evolving version of Willotropolis, the current 3D learning community of The Willoway cyberschool, an accredited 7-12 Internet school. Willoway's learning methodology is based on the theory of Constructivist Learning. Constructivist Learning encourages and accepts student autonomy and initiative. It is not passive. It is interactive. Willoway students create 3D virtual worlds where they show what they have learned in unique ways inside Willoway's 3D learning worlds.

Willoway students don't just get their assignments online: they create projects, individually and in teams, that are posted on Willoway's web site at http://www.willoway.com as well as build up the virtual 3D world. Students construct meaning by doing under this theory. They role-play historical characters and put on plays for other Willoway students, create interactive games—all at a distance. This creative approach to learning prompts students' pursuit of connections among ideas and concepts. Students who frame questions and issues and then go about answering and analyzing them take responsibility for their own learning and become problem solvers and, perhaps more important, problem finders. These students—in pursuit of new understandings—are led by their own ideas and informed by the ideas of others. This is the basis for the Willoway Method.

Willoway students touch on several areas of interactive design by working in groups to build the ever-evolving 3D world. This 3D world is wildly popular with our students as it allows creativity like no other means we have seen at a distance. Students can participate in simulations, create and act out plays, create intricate mazes for other students to travel through and role-play historical characters. The 3D world is only as limited as the students' imaginations themselves.

These students ask for, if not demand, the freedom to play with ideas, explore issues, and encounter new information. It is for this reason that we have now outgrown our Palace 3d world called Willotropolis. Students are in need of a more expressive learning environment and are driving us forward. To assist in achieving these objectives, Wilotown adds the following features: central administration, student portal, faculty portal, conference center, content portals, fantasy/science fiction portal, history portal, and science portal. The Central administration area is where prospective families and students can learn about the Willoway program, apply online and get general information on Willoway. In the Student Portal, each student will have their own individual habitats where they can socialize and be during the school day when they are not attending class. This area includes online gaming, a music portal and other entertainment features. The Faculty Portal includes teacher habitats and offices as well as an informational portal. The Conference Center has live virtual classes, where the content portals are the bulk of the Wilotown world. Students create virtual learning portals centered around the Willoway curriculum. Example content portals are a Fantasy/Sci-Fi Portal, a History Portal (example: Middle Ages World), a Science Portal, etc. Other great examples of how the new home at AWEDU deals with how all areas of the curriculum have been integrated. The way a teacher frames an assignment usually determines the degree to which students may be autonomous and display initiative. For example, students in a 9th grade Willoway English class read Journey to the Center of the Earth by Jules Verne. The novel was integrated with a Willoway science unit on volcanoes. After discussing the text in online literature study groups, students went on to incorporate fact with fiction by creating their own virtual volcano world where characters from the novel came alive inside Willoway's 3D learning community. Students wrote a play where the main characters took other Willoway students on an interactive journey to the center of the earth. Each character had a chance to “speak” and explain the setting and context of the volcano game. Students then acted as tour guides and partnered with other Willoway students to take them deep inside the volcano. Various earth science facts were embedded into the 3D game exemplifying student knowledge. Willoway students are taught to think for themselves and to create on a daily basis.

Another example when students created a 3D world was during the Mars2030 project. Students created their own online 3D virtual Mars world. They integrated science knowledge learned about Mars, and then created their own version of what it might be like to live in a Mars colony. They programmed a 3D world as well as learned how to use Bryce 3D to make room backgrounds. They wrote journal entries “looking” out their Mars colony portals and shared what they “saw.” We would like to now move onto to more advanced 3D modeling explorations using Activeworlds. Throughout the Willoway school year, from the introductory lessons on how to create 3D rooms to the design and collaborative hands-on building exercises, the following areas are stressed:

3-D Interfaces: student engage in hands-on construction of 3-D spaces and interfaces. Tools available for building: TrueSpace, Bryce 3D, VRML, Realpublisher. We also will explore sound and voice which can be attached or transmitted through the space, and images which can be generated by scanning or paint systems and mapped onto objects. In addition, controls to affect the behavior of objects, selectable surfaces, and links to Internet sites and other media will be added into the 3-D scenes.

Cooperative and Participatory interaction design: collaborative design and hands-on construction of several different types of portal within Wilotown will be undertaken. The interactive volcano world for the Journey to the Center of the Earth project is a good example of this. Each team began the design of the new learning portal with a brief brainstorming period, and then they developed it further on paper and whiteboard. After this was accomplished, they presented it to the whole group for critique and then proceed with the on-line construction of the space and its interfaces. This is all accomplished with students in physically remote locations.

Social issues: the use of special terms, and norms of community behavior are highlighted during these explorations and help students simulate real learning. The migration of Willotropolis to colonize Activeworlds brings new challenges for interactive graphics, social psychology, and the aesthetics of world design. Willoway students will be able to build their own worlds where they can create their own community structures and make sense out of learning.

After working with students at a distance extensively, this experience has identified several key ingredients that help make the experience more successful. First of all, the students who actively participate, who get online everyday in a good routine, who attend all schedule conferences and who TRY to become part of our close-knit community are the ones who are successful. On the other hand, students who for one reason or another have distanced themselves from other students, don't attend conferences and have minimal contact during the school day invariably don't succeed with us. The more kids are interaction, talking to teachers, making friends, asking for help and HAVING FUN the better they do academically at a distance. It's for these reasons that the integration of Wilotown has proceeded full force. Many parents have read some of the articles at the Willoway site about Contructivist Teaching and how Willoway applies it. Some of you high school students might be interested in reading it now too. Students learn best by doing, by sharing, by creating interactive projects. You also learn best by having active involvement with other people. This is where Wilotown comes in. We had great success with our old Palace world called Willotropolis and some of our students had a hard time saying goodbye to it. In my search for a better 3D learning world we found Active Worlds and I was thrilled with the results. Wilotown in now the virtual campus of Willoway. All teachers and students will be expected to “come to school” in Wilotown each day. For those students already on a good schedule, who get on ICQ each day, who come to class, who access your feedback etc., then the changes will be transparent. For those students who have not been too involved on these levels it is now a requirement. Teachers will not be on ICQ starting second semester. They will have office hours in Wilotown. Students are required to proceed to their office and knock on their door or send them a telegram in there. Willoway has also set up a new private audio chat room to be used in the Wilotown classrooms so there will be no distractions during class. Once a student comes into a scheduled class, the classroom door“closes” and unless there are unforseen circumstances, then a tardy student will not be allowed into the class after it has started. The student is required to run ReallyEasy Interactor as the main messaging program but may run ICQ on the student's off school hours to talk to friends. If the student computer is fast enough, the student can run it side by side with Reallyeasy Interactor and Wilotown but such a configuration may consume too much memory.

Students are required to come into Wilotown each morning at 8:30 their time to access the daily assignments and check the conference schedule. There will be occasional morning opening sessions in the Willotorium as well. Students need to check office hours if they need to come talk to a teacher or use the telegram feature in Wilotown. There are detailed “rules to follow.” Students are encouraged to actively participate in Wilotown during the school day as the student works on assignments. A student can possibly sign on, get assignments, say hi to teachers, then go to your “desk” in the student's home to get to work. Then, when it's time for class, the student comes over to the main building.

Cuseeme is used to work on some upcoming collaborative projects and a simple whiteboard is integrated right into Wilotown. Coupled with the audio chat room that allows everyone to surf to web pages, we feel students have an effective experience and have fun in the process!

These changes raise the question of why students must go to a virtual school when the students can just come to the website as they used to? There are many reasons. One reason has to do with the psychological implications participating in a virtual world has. Please read some of the studies being done on this subject and ask yourself . . . why is that students seem to LOVE working in 3D worlds. The answer is that is stimulates reality! Another reason is that it builds in accountability. Teachers can “see” who in participating, what they are up to and who comes to class.

### Wilotown Nettiquete

### Teacher Considerations

1. If you approach a door that is closed, please hover your mouse over the door to read any message that might be posted. Just because a teacher might be in their office does not mean that they are available. Please try to contact your teacher during the scheduled office hours. Doors in Wilotown are now set up so you can not walk through them. A teacher will create the “solid off” on the other side of the door to allow you to walk through and enter the office if they are available.

2. Try to enter your scheduled classroom at least 5 minutes before class. Once the scheduled class time arrives, teachers will close the doors and take “solid off” off the door to shut it. This is to discourage students from entering after the start of class. If you have technical difficulties or other extenuating circumstances then it is left to the individual discretions of your teachers to allow you into the class after the start of the class. All students are required to attend class as part of course requirements. Students not attending on a regular basis and not trying to participate may have their enrollment spot released.

### General Considerations

1. Chatting inside Wilotown is monitored at all times. If you would like to say something private to your friends then please use the whisper feature, send a telegram, or use the audio ReallyEasy Interactor panel.

2. Please use consideration with the constructions of your personal student home in the student housing section. Creating and leaving signs posted relating to other students is absolutely forbidden. If you need to leave a message for another student then use the telegram feature.

3. Do not build your house up higher than two stories. Houses higher than that may be disassembled without notice and you would have to start over again.

4. Remember that the theme of our town is futuristic. Student using building materials that do not conform to this theme may find parts of their home disassembled.

Most teachers, regardless of the approaches they have used in the past, view constructivism as the way they've “always known people learn.” Most of these teachers coming out of the traditional educational setting believe that they have been prevented from teaching in accord with that knowledge by a combination of rigid curriculums, unsupportive administrators, and inadequate pre-service and in-service educational experiences. Once offered the opportunity to study and consider the role of constructivism in educational practice, they tend to view the inclusion of such teaching practices as natural and growth producing. Once teachers are exposed to these practices and how they can enhance a distance education experience, they enthusiastically experiment with constructivist pedagogy until it becomes part of the very fabric of their online classrooms.

Some teachers coming out of a traditional classroom setting are more concerned with behavior management issues than with student learning, and they are fearful that the constructivist approach to teaching will erode some of their control. When a teacher arranges classroom dynamics so that she is the sole determiner of what is “right” in the classroom, most students learn to conform to expectations without critique, to refrain from questioning teacher directives, and to look to the teacher for judgmental and evaluative feedback. The rest disengage. Em-powering students to construct their own understandings, therefore, is perceived by these teachers as a threatening break from the unwritten but widely understood hierarchical covenant that binds teachers and students. At Willoway, we strive to change the way teachers approach their teaching.

Becoming a teacher who helps students to search rather than follow is challenging and, in many ways, frightening. Teachers who resist constructivist pedagogy do so for understandable reasons: most were not themselves educated in these settings nor trained to teach in these ways. The shift, therefore, seems enormous. And, if current instructional practices are perceived to be working, there is little incentive to experiment with new methodologies—even if the pedagogy undergirding the new methodologies is appealing.

But becoming a constructivist teacher is not as overwhelming as many teachers think. Good teachers are already implementing many constructivist practices and don't even know it. Applying constructivist teaching methods in a distance learning program is the focus of this discussion. We have found that the following set of descriptors of constructivist teaching behaviors provides a usable framework within which teachers can experiment with this new approach at a distance. This set of descriptors presents teachers as mediators of students and environments, not simply as givers of information and managers of behavior. It is based on our own interactions with students and observations in a distance education setting. The development of these descriptors has also been informed by the work of several researchers and theoreticians, including Sigel, Elkind, Kuhn, and Arlin (see bibliography).

1. Constructivist teachers encourage and accept student autonomy and initiative. While the philosophies and mission statements of many schools purport to want students to be thinking, exploring individuals who generate hypotheses and test them out, the organizational and management structures of most schools militate against these goals. So, if autonomy, initiative, and leadership are to be nurtured, it must be done in individual classrooms.

Autonomy and initiative prompt students' pursuit of connections among ideas and concepts. Students who frame questions and issues and then go about answering and analyzing them take responsibility for their own learning and become problem solvers and, perhaps more important, problem finders. These students—in pursuit of new understandings—are led by their own ideas and informed by the ideas of others. This is the basis for the Willoway Method. These students ask for, if not demand, the freedom to play with ideas, explore issues, and encounter new information. The way a teacher frames an assignment usually determines the degree to which students may be autonomous and display initiative. For example, students in a 9th grade

Willoway English class read Journey to the Center of the Earth by Jules Verne. The novel was integrated with a Willoway science unit on Earth Science. After interactive discussing the text in online literature study groups, students went on to incorporate fact with fiction by creating their own virtual volcano world where characters from the novel came alive. These characters, portrayed by students took other Willoway students on an interactive journey to the center of the earth. Students created a play where each character had a chance to “speak” and explain the setting and context of the volcano game. Students then acted as tour guides and partners with another Willoway student to take them deep inside the volcano. Various earth science facts were embedded into the 3D game exemplify student knowledge. Our students are taught to think for themselves and to create on a daily basis. The reverse is true in many traditional classroom settings AND other distance education programs.

Conscientious students who are acculturated to receiving information passively and awaiting directions before acting will study and memorize what their teachers tell them is important. Robbing students of the opportunity to discern for themselves importance from information because teachers are worried about maintaining classroom control will prevent the transformation-seeking classroom, both online and offline.

2. Constructivist teachers use raw data and primary sources, along with manipulative, interactive, and physical interaction. Concepts, theorems. algorithms. laws, and guidelines are abstractions that the human mind generates through interaction with ideas. These abstractions emerge from the world of phenomena such as falling stars, nations at war, decomposing organic matter, gymnasts who can hurl their bodies through space, and all the other diverse happenings that describe our world. The Constructivist approach to teaching presents these real-world possibilities to students, then helps the students generate the abstractions that bind these phenomena together. When teachers present to students the unusual and the commonplace and ask students to describe the difference, they encourage students to analyze, synthesize, and evaluate. Learning becomes the result of research related to real problems—and is this not what schools strive to engender in their students? For example, students can read historical accounts of the effects of the social policies of the early 1980s on the economic and educational profile of the African-American population in the United States. Or, students can be taught to read the census reports and allowed to generate their own inferences about social policies. The former relies on the authority of a stranger. The latter relies on the ingenuity of the individual student. Lists of figures and pages of charts are probably not the first images evoked when the terms “hands on” or “manipulative” are heard. But the census data can tell a loud story if the right pages and lists are highlighted in the context of a good question.

3. When framing tasks, Constructivist teachers use cognitive terminology such as “classify,” “analyze,” “predict,” and “create.” The words we hear and use in our everyday lives affect our way of thinking and, ultimately, our actions. The teacher who asks students to select a story's main idea from a list of four possibilities on a multiple-choice test is presenting to the students a very different task than the teacher who asks students to analyze the relationships among three of the story's character or predict how the story might have proceeded had certain events in the story not occurred. Many distance education programs are set up to sabotage the Constructivist method in order to achieve automation and less involvement from the teachers. Willoway strives to humanize the distance education experience.

4. Constructivist teachers allow student responses to drive lessons, shift instructional strategies, and alter content. This descriptor does not mean that students' initial interest, or lack of interest, in a topic determines whether the topic gets taught, nor does it mean that whole sections of the curriculum are to be thrown out if students wish to discuss other issues. However, students' knowledge, experiences, and interests occasionally do focus around an urgent theme. Such was the case during the lost of NASA's space probes during the winter of 2000. Students at all grade levels were compelled by the images they saw, the reports they heard, and the fears the scientists portrayed. The whole school was working on the Mars 2030 project at the time and had just finished creating their own online 3D virtual Mars world. News reports of the lose of the Mars Polar Lander was taken hard by students but we tried to use the example as a teachable moment and grow from it. It was a prime example from the real world about what can happen to even the most brilliant scientists. As educators, we have each experienced moments of excitement in the classroom, moments when the students' enthusiasm, interest, prior knowledge, and motivation have intersected in ways that made a particular lesson transcendental and enabled us to think with pride about that lesson for weeks.

We recall the gleam in our students' eyes, their excitement about the tasks and discussions, and their extraordinary ability to attend to the task for long periods of time and with great commitment. If we were fortunate, we encountered a handful of these experiences each year, and wondered why they did not occur more eloquently. It's unfortunate that much of what we seek to teach our students is of little interest to them at that particular point in their lives. Curriculums and syllabi developed by publishers or state-level specialists are based on adult notions of what students of different ages need to know. Even when the topics are of interest to students, the recommended methodologies for teaching the topics sometimes are not. Little wonder, then, why more of those magnificent moments don't occur. At Willoway, using the Constructvist method helps to enable more valuable learning experiences. Willoway teachers are given latitude regarding content, and all generally, have a good deal of autonomy in determining the ways in which the content is taught even in a distance education program For example, the Willoway science curriculum called for students to begin learning about the “scientific method” and to conduct some rudimentary experiments using this method: ask a question (develop an hypothesis), figure out a way to answer the question (set up an experiment), tell what happens (record your observations), and answer the question (support or refute the initial hypothesis). One 7^{th} grade teacher asked her students, during an introductory video conference, asked students to talk about their favorite things there in their individual homes. One student, Anna, spoke about her cat as she held it up to the camera. A classmate, Nick, discussed his house plants as he showed examples of ones he could hold. Capitalizing on their responses, the teacher asked Anna and Nick to think of questions each had about the cat and the plants. Anna wanted to know if her cat would like other cat foods as much as he liked the brand he normally ate. Nick wanted to know how plants grow. Through the teacher's mediation, Anna organized an experiment to answer her question about cat food. She arranged four different brands of cat food in four different bowls and placed them on the floor. When the cat entered the room, she observed which bowl he went to initially and from which bowl he ate.

Anna changed the positions of the bowls and tried the experiment again. She used her digital camera to document the process. Ultimately, she concluded that her cat preferred one brand over the others. With his teacher's mediation, Nick focused his question: Does the human voice affect the growth of a plant? Nick planted four bean seeds in four different pots and placed them all on the same shelf near a window. Each day he took each pot, one at a time, into another room. He spoke daily to one of the bean plants. He sang daily to a second plant. He yelled daily at a third plant. And he completely ignored the fourth. He recorded his observations over four weeks and concluded that the plants to which he spoke and sang grew the most. The students' thinking drove these experiments, and the teacher's mediation framed the processes that followed. Visualizing how Constructivist teaching can be applied at a distance is an ever-evolving skill for teachers. The curriculum content—exploration of the scientific method—was addressed faithfully in a different manner for each student.

5. Constructivist teachers inquire about students' understandings of concepts before sharing their own understandings of those concepts. When teachers share their ideas and theories before students have an opportunity to develop their own, students' questioning of their own theories is essentially eliminated. Students assume that teachers know more than they do. Consequently, most students stop thinking about a concept or theory once they hear “the correct answer” from the teacher. It's hard for many teachers to withhold their theories and ideas. First, teachers do often have a “correct answer” that they want to share with students. Second, students themselves are often impatient. Some students don't want to “waste their time” developing theories and exploring ideas if the teachers are “on the wrong track.” So teachers sometimes feel great pressure from students to offer the “right” answer. Third, some teachers adhere to the old saying about knowledge being power. Teachers struggling for control of their classes may use their knowledge as a behavior management device: when they share their ideas, the students are likely to be quiet and more attentive. And fourth, time is a serious consideration in many online classrooms.

The curriculum must be covered, and teachers' theories and ideas typically bring closure to discussions and move the class on to the next topic. Constructivist teachers, for the most part, withhold their notions and encourage students to develop their own thoughts. This can be a tricky area in an online setting as teachers need to manage conferences and keep things moving along.

Approximated spelling is a good example of knowing when to make comments and when not to. to keep the flow of text coming during conferences that rely on text-based communications, it would be inappropriate to continually stop the conference and point out misspellings. Usually the teacher chooses not to correct spelling but, instead, to permit' student to continue approximating the spelling of words. Interestingly, when in a conference setting, many students recognize their own mistakes and enter the correct spelling in the next text entry they make. “Oh, I added an e at the end of volcano” No one told the student that their spelling was incorrect. They reformulated their own work in the process of sharing it. Their reformulation was a self-regulated event. The teacher's plan to share her understanding of the conventional spelling, in this case, became unnecessary.

6. Constructivist teachers encourage students to engage in dialogue, both with the teacher and with one another. One very powerful way students come to change or reinforce conceptions is through social discourse. This is critical in a distance education program. Having an opportunity to present one's own ideas, as well as being permitted to hear and reflect on the ideas of others, is an empowering experience. The benefit of discourse with others, particularly with peers, facilitates the meaning-making process. Over the years, most students come to expect their teachers to differentiate between “good” and “bad” ideas, to indicate when responses are “right” and “wrong,” and to transmit these messages in a fairly straightforward way. Dialogue is not something most students coming out a traditional setting are encourage to do. Consequently, most students learn to offer brief responses to questions, and to speak only when they are reasonably certain that they are supporting either a “good” idea or the “right” answer. Keeping students quiet does not help them construct new understandings or reflect on old ones.

An 8th grade teacher decided she wanted to offer a wider literature selection to their students and to engage the students in more thorough analyses of important ideas. She organized a series of online Literature Study Circles. In a Literature Study Circle a group of about eight students and an adult read and discuss the same book. The students select the book they wish to read from a master list compiled by the teacher, and the school's schedule is altered so that the groups can meet twice for 45 minutes during a three-week period. During the first meeting the teacher sets the context for the book by asking questions about students' prior experiences that relate to the storyline. In an online setting teachers can record herself reading the book aloud to the students as a break in reading individually. The second meeting is devoted to a discussion about the book. In one Literature Study Circle, students had read Of Mice and Men. The issues raised by students during the post-reading discussion, issues generated by questions and contradictions posed by the teacher, included treatment of people with disabilities, sexism, the distribution of wealth and power in our nation, friendship, and death. The teacher orchestrated the discussion so that quiet students also had a chance to come up to the whiteboard and participate, but the ideas that drove the discussion belonged to the students and were fueled by student-to- student dialogue. Student-to-student dialogue is the foundation upon which cooperative learning (Slavin 1990) is structured. Reports state that cooperative learning experiences have promoted interpersonal attraction among initially prejudiced peers (Cooper et al. 1980), and such experiences have promoted inter-ethnic interaction in both instructional and free-time activities (Johnson et al. 1981). The benefits of peer-to-peer dialogue among teachers reinforces its potential for students. Using the Willoway Teamwave interactive whiteboard promotes cooperative learning.

Students working on an electricity unit were asked to design, in cooperative learning groups, a system for a family to generate electricity for its home, using windmills. The stipulation that no batteries could be used was included in the instructions. During a whole-class discussion of each group's work-in-progress, the issue of energy storage led quickly to a discussion of batteries. Most students defined “battery” in terms of what one typically purchases in a store: an electrolytic cell such as the type used in toys and flashlights, or larger cells such as those used to power automobiles.

Three students, however, defined a battery as any device that can store energy, such as an expanded balloon or a tank of hot water. This differing opinion on the battery definition opened up the dialog and student thinking. Two weeks later, while this same class grappled with another, seemingly simple problem “how to redraw silhouettes in half the original size—one student, after much consideration of the question, declared: “Now we're trying to figure out what ‘half really means. I still want to know: What is a battery!” In each of these online sessions, the students addressed their questions and statements to one another. The teacher clarified the questions they raised of one another and demanded accuracy of word choice, but the communication currents were between and among the students and led to deeper understandings of the topics at hand.

7. Constructivist teachers encourage student inquiry by asking thoughtful, open-ended questions and encouraging students to ask questions of each other. If we want students to value inquiry, we, as educators, must also value it. It must be worked into every good educational program, offline or on. If teachers pose questions with the notion that there is only one correct response, how can students be expected to develop either the interest in or the analytic skills necessary for other means of inquiry? Schools too often present students with one perspective: Columbus was a courageous explorer who discovered America (What does that imply about the Native Americans here when he came ashore? Complex, thoughtful questions challenge students to look beyond the apparent, to delve into issues deeply and broadly, and to form their own understandings of events and phenomena. Knowing, for example, that Columbus' ships carried with them diseases for which Native Americans had no antibodies and that Columbus and his men enslaved Native Americans for the return voyage home enables students to view the historical development of our nation in terms of Columbus' calculated and uncalculated risks, and tile Native Americans' subsequent oppression.

Fostering appreciation for a multiplicity of truths and options is the “real” mission of education because “real” problems are rarely unidimensional. In one 9th grade virtual classroom, a teacher formed “consultant groups.” Each student became a consultant on a self-selected topic to research on the Internet and was responsible for keeping the rest of the class informed about that topic. Each consultant belonged to a small group of students who were charged with questioning each other in order to learn about the chosen topics. One student became quite knowledgeable about volcanoes—so much so, in fact, that he gave “lectures” on the topic to other grade levels as a guest speaker. One day, the student was describing to his group how volcanoes develop in certain regions. As his group members considered this new information, one student asked him about whether a volcano could be developing underneath his home in Michigan. If it were possible, he wanted to know how they would know if one were developing. The student-consultant carefully pondered this question and said, “I don't think that volcanoes could develop there, but I'm not sure. But, I think we would know if a volcano were developing there.” “How!” one of the other students asked, “Well,” the student-consultant responded, “if a volcano were under your house, the grass would be turning brown from the heat. As long as the grass is green, I think you're safe.” Discourse with one's peer group is a critical factor in learning and development. Schools need to create settings that foster such interaction.

8. Constructivist teachers seek elaboration of students' initial responses. Initial responses are just that—initial responses. Students' first thoughts about issues are not necessarily their final thoughts nor their best thoughts. Through elaboration, students often reconceptualize and assess their own errors. For example, one middle school mathematics teacher assigned his class problems he had entered in the whiteboard classroom. A student, looking quite confused, asked the teacher if her approach to solving one of the problems was appropriate. The teacher asked the student to explain what she had done by taking the teacher step by step through the problem on the whiteboard. As she was explaining her approach in a step-by-step manner, she recognized her own procedural error. She drew a :) typed, “I forgot to multiply both sides of the equation by x.” The teacher based his responses to the student on the premise that he could learn more about what teaching steps to take in subsequent lessons with the student than he could learn from simply fixing the mistake for her. Student elaboration enables adults to understand more clearly how students do and do not think about a concept. It's also critical in the online learning environment as many times there are multiple meaning that need to be clarified. Your point does not always come across the first time at a distance.

9. Constructivist teachers engage students in experiences that might engender contradictions to their initial hypotheses and then encourage discussion. Cognitive growth occurs when an individual revisits and reformulates a current perspective. Therefore, Constructivist teachers engage students in experiences that might engender contradictions to students' current hypotheses. They then encourage discussions of hypotheses and perspectives. Contradictions are constructed by learners. Teachers cannot know what will be perceived as a contradiction by students; this is an internal process.

But teachers can and must challenge students' present conceptions, knowing that the challenge only exists if the students perceive a contradiction. Teachers must, ‘therefore, use information about the students’ present conceptions, or points of view, to help them understand which notions students may accept or reject as contradictory. Students of all ages develop and refine ideas about phenomena and then hold onto these ideas as eternal truths. Even in the face of “authoritative” intervention and “hard” data that challenge their views, students typically adhere staunchly to their original notions. Through experiences that might foster contradictions, the frameworks for these notions weaken, causing students to rethink their perspectives and form new understandings. Consider the following example: During an 11th grade discussion about the causes of World War I, one student contended with great conviction that the assassination of the Archduke Ferdinand of Austria caused the war. The teacher then asked, “If the Archduke had not been assassinated, can you tell us what would have happened with the economy and politics of the region?” After a moment's thought, the student said, “I guess they wouldn't have changed that much.” The teacher then asked, “Would anything else have changed? How about Germany's quest to rule Europe?” The student replied, “I can't think of anything that would have changed, except that maybe the Archduke would still be alive.” “Then,” continued the teacher, “what was it that made this event the cause of the war?” The student, now quite enmeshed in thought, said, “I guess that maybe it [the war] could have happened anyway. But, the killing of Austria's Archduke gave the Germans an excuse to begin their plan to conquer all of Europe. When Russia and France jumped in to help Serbia, the Germans declared war on them, too. But, I think I see what you mean. It was probably going to happen anyway. It just happened sooner.” Note that this elaborate explanation didn't come from the teacher. It came from the student. Note also that the student said, “I think I see what you mean,” as if the meaning came from the teacher. But it did not. The meaning was constructed by the student who was ready and able to understand a different point of view.

When the student revealed his original perspective, the teacher was presented with the opportunity to intervene; but the contradiction was constructed by the student. In this example, the teacher challenged the student's thinking with questions. The questions provided a way for the student to reveal very sophisticated understandings of the events and political sub currents. The teacher never directly told the student to look at the assassination as a catalyst rather than a cause. She simply wanted to present a way for the student to consider this perspective as an option. The student quickly embraced this view. Some other students in the class didn't distinguish between a catalytic event and a causal event. They didn't construct the same “contradiction” that this student constructed. The teacher then directed the class discussion to other students with subsequent questions such as: “Who also thinks that war would have just happened sooner?” “Why? “Who disagrees?” “For what reason?” Without acknowledging one answer as better than another, everyone can participate and listen to others.

10. Constructivist teachers allow wait time after posing questions. Several years ago, as part of its professional development efforts, a school district hired a graduate student to tape script lessons in individual classrooms. The project was organized to provide feedback to teachers about their instructional practices: several one-minute snippets were tape recorded during a lesson, and then transcribed into writing for the teachers' reflection. One teacher, generally acknowledged to be highly skilled, was appalled to discover that she asked and answered questions in virtually the same breath. Students had no time to think about the questions she asked and quickly learned simply to wait for her to answer her own questions. Similarly, another teacher found out that she had inadvertently orchestrated competition in her classroom. The first two or three students to raise their hands were, by and large, the only ones ever called on. If students didn't get their hands in the air immediately, they were effectively locked out of the “discussion” questions.

These two examples illustrate the importance of wait time. How does this apply in an online classroom setting? Students must be taught that the wait time between questions must be respected. One way to do this and to prevent students from jumping in too soon is to have the type a ? if they want to answer a question if it's a text-based learning environment. There are students who, for a variety of reasons, are not prepared to respond to questions immediately. They process the world in different ways. Environments that require immediate responses prevent these students from thinking through issues and concepts thoroughly, forcing them, in effect, to become spectators as their quicker peers react. They learn over time that there's no point in mentally engaging in teacher-posed questions because the questions will have been answered before they have had the opportunity to develop hypotheses.

Another reason students need wait time is that questions posed by teachers are not always the questions heard by the students. Firing off, asking and answering questions in a rapid manner does not provide an opportunity for the teacher to sense the manner in which most of the students have understood the questions. Besides increasing wait time after questioning in large-group formats, we have had success with posing questions and then encouraging small groups of students to consider them before the whole group is invited back together to report on the deliberations. Having student go into another “room” in the conference center is a great way to encourage collaborative discussion. When the group is done trading ideas they can come back into the main virtual classroom. This format allows the teacher to call on students to deliver the group's initial responses without putting anyone on the spot. In addition, any student in the group can submit a “minority report.” Thus, teachers take sensitive leadership over the orchestration of classroom dialogue and provide opportunities for all students to participate in different ways while encouraging students' intellectual autonomy.

11. Constructivist teachers provide time for students to construct relationships and create metaphors. This activity took nearly 45 minutes, during which some students went beyond these initial relationships and joined forces with their peers to create every great number of relationships, patterns, and theories were generated during this activity, and none of them came from the teacher. The teacher structured and mediated the activity and provided the environment for learning to occur, but the students constructed the relationships themselves.

Constructivist teachers nurture students' natural curiosity through frequent use of the learning cycle model. The learning cycle model has a long history in science education. The most popular description of this model was published by Akin and Kara. Highlighting the important role of self-regulation in the learning process, the model describes curriculum development and instruction as a three-step cycle. First, the teacher provides an open-ended opportunity for students to interact with purposefully selected materials. The primary goal of this initial lesson is for students to generate questions and hypotheses from working with the materials.

This step has historically been called “discovery.” Next, the teacher provides the “concept introduction” lessons aimed at focusing the students' questions, providing related new vocabulary, framing with students their proposed laboratory experiences, and so forth. The third step, “concept application,” completes the cycle after one or more iterations of the discovery-concept introduction sequence. During concept application students work on new problems with the potential for evoking a fresh look at the concepts previously studied. Note that this cycle stands in contrast to the ways in which most curriculum, syllabi, and published materials present learning, and the ways in which most teachers were taught to teach. In the traditional model, concept introduction comes first, followed by concept application activities. Discovery, when it occurs, usually takes place after introduction and application, and with only the “quicker” students who are able to finish their application tasks before the rest of the class.

Let's take a look at how this cycle evolved in a 9th grade earth science virtual classroom. In this classroom, the teacher told the students about the Chinook winds, the warm, dry, fast winds that blow down from the Rocky Mountains into the region just east of the mountains. The winds can be 40″-50″ warmer than the surrounding air. In this example, the material made available for discovery purposes was a scenario for the students to consider. The teacher asked the students to work in small groups in different Teammate rooms to generate a diagram that could explain why this occurrence might happen. As the groups began to work, the teacher visited each virtual workroom and watch the students' deliberations, intervening in different ways dependent on the course of the dialogue occurring among the students. She asked a group that was “stuck” to begin by drawing the vegetation on the sides of the mountain. While trying to do the drawing, the students began to talk about rainfall, where it comes from, the patterns of cloud movement, and so on. At that point, the teacher moved to another Teammate workroom where a group of students was having a conversation about how hot air rises. The teacher asked another group, “Why does the warm wind move down if hot air rises?” One girl in the group said emphatically, “That's what I don't understand!” Music to a Constructivist teacher's ears!

The teacher said: “You know what your problem is now. Don't forget that the wind is fast, too.” And the teacher moved on to students with whom she had not yet interacted that day. What was the concept introduction to follow this discovery opportunity? The teacher wanted to introduce the concept of adiabatic pressure—a most sophisticated concept that without consideration of heat gain and heat loss, wind speed, and moisture conditions is largely inaccessible. The Chinook winds activity allowed the teacher to assess what elements of the concept are within the students' intellectual reach.

Good teaching can take place at a distance. Willoway tries to view its program as embodying the best of what traditional classrooms offer with the advances of technology to bring students together at a distance.

These 12 descriptors highlight teacher practices online that help students search for their own understandings rather than follow other people's logic. The following references provide background information on the teaching methodologies implemented in the novel electronic and interactive environment of Wilotown: Akin, J M, and R. Karplus. (1962). “Discovery or Invention” Science Teacher. 29, 5: 45; Cooper, L., D. Johnson, R. Johnson, and E Welderson. (1980). “The Effects of Cooperative, Competitive, and Individualistic Experiences in Inter-Personal Attractions Among Heterogeneous Peers.”; The Journal of Social Psychology 111: 243-252. Johnson, D., and R. Johnson. (1981). “Effects of Cooperative and Individualistic Learning Experiences on Inter ethnic Interaction.”; Journal of Educational Psychology 73, 3, 444-449. Slavin, R. (1990). Cooperative Learning Theory, Research and Practice. Englewood Cliffs, N. J.: Prentice-Hall.

### Future Direction

Willoway's vision is to provide the most interactive online learning experience possible. We strive to integrate emerging technologies on an ongoing basis, to replenish our knowledge and educational strategies, and to accommodate the most effective teaching at a distance. The role of intellectual capital for Willoway is to create the innovations that will become the products and services of the future. This includes new course content, interactive 3D learning projects via our Palace learning world and the integration of new and emerging technologies. We add value through the addition of online learning content in all areas of the curriculum as well as the gradual evolution of our student-built Web site. Willoway's intellectual capital is integral in creating and maintaining our reputation and image which we use to differentiate ourselves in the marketplace. We are known as the most technically progressive Internet home school/distance education program on the market today.

Willoway uses a unique circle of learning that involves using the creativity and knowledge of all employed educators, our parents and particularly the students themselves. This human capital helps develop the technology and the innovations that we use as the basis for our current services and services in the future. The knowledge discovered pertaining to new technologies by the students themselves drives much of what we do. Our business model is designed for the fast change the Internet demands and as a result, we remain competitive.

Our vision describes Willoway as it wishes to be in the future. Our vision provides the standard against which a new innovation is measured: Will the innovation help us achieve our long-term vision? Can Willoway capitalize on or somehow use the innovation to improve internal operations? How it is viewed by the marketplace? Will it lead to increased sales? Will it improve internal efficiency? Will it improve the Willoway's ability to develop new innovations? Are these things important to us? If so, the idea has value. If not, then the idea has little value.

The values of Willoway represent the consensus beliefs of everyone involved in the school. The sum of these views, the collective values of Willoway, determine the world view held by the employees. Values drive the employees' day-to-day decision making and if their values differ from those of the executive management, the employees will be unlikely to implement Willoway's strategic plan effectively. Values may be thought of as ideals that shape and give significance to our lives. They are reflected in the priorities we choose, the decisions we make, and the actions we take. As decision prioritizes, values are reflected in behavior. As ideals, they provide meaning for people's lives. Values are also measurable. They represent the lens through which individuals and organizations view the world. An item has value (i.e., worth) to us if it is consistent with our values. Items that are not consistent with Willoway's values have little value to us. Values set the context within which Willoway may determine what it holds to be of value (or worth). Vision sets the benchmark against which Willoway measures the value of our intangibles. Willoway creates sustainable value through the creation of knowledge and know-how. Some of that knowledge and know-how becomes codified and forms intellectual assets; the remainder is tacit knowledge that remains within the human capital. Willoway institutionalizes much of the knowledge and know-how generated by our human capital (R&D Staff, teachers, students, parents) values and culture of the firm mission, vision, objectives, and strategy of the firm customer relationships and know-how about customers technical knowledge and know-how. Commercializable innovations strategic innovations (part of the firm's strategic thrust) non-strategic innovations (available for out- licensing or other value-capturing process) other innovations that bring value to the firm innovations for internal operations of an Internet school innovations that protect commercializable innovations.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A method of distance education comprising:
establishing a server in a communications network, with the server having data information relating to an educational subject, the data information including at least one of the following: information content, linked web resources, quizzes, and tests;
connecting a teacher and a plurality of students over the communications network; and
conducting a conference between the teacher and plurality of students relating to the educational subject and referring to the data information.

2. The method of claim 1 further comprising a step of providing a virtual school which is accessible over the communications network, and wherein at least one of the steps of connecting and conducting are implemented utilizing the virtual school.

3. The method of claim 2 wherein the virtual school includes a three dimensional three dimensional representational capability.

4. The method of claim 1 further comprising a step of providing a student work assignment arena accessible over said computer network, the assignment arena providing at least one student assignment data file, and wherein said conducting step involves hosting a discussion relating to the student assignment data file on said assignment arena.
